(19) United States
(12) Patent Application Publication
(10) Pub. No.: US 2009/0192924 A1
(43) Pub. Date: Jul. 30, 2009

(54) Method and System for Providing Mobile Inventory Control Service Using Mobile Communication Terminal

(75) Inventor: Young Bae Ku, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignee: GMARKET INC., Seoul (KR)

(21) Appl. No.: 12/356,153

(22) Filed: Jan. 20, 2009

(30) Foreign Application Priority Data
Jan. 21, 2008 (KR) 2008-0006099

(51) Int. Cl. G06Q 10/00; G06F 17/30; G06F 17/40; H04W 4/00

(52) U.S. Cl. 705/28; 707/3; 707/6; 707/E17.044; 707/E17.014; 455/466

(57) ABSTRACT

A method and system for providing mobile inventory control service using a mobile communication terminal are provided. The method for providing mobile inventory control service includes receiving a text message containing goods information from a mobile communication terminal of a seller; searching for goods corresponding to the received goods information; and setting an inventory status of the searched goods to an out-of-stock status or ending the out-of-stock status.

### CROSS-REFERENCE TO RELATED APPLICATION

This application claims priority to and the benefit of Korean Patent Application No. 2008-6099, filed on Jan. 21, 2008, the disclosure of which is incorporated herein by reference in its entirety.

### BACKGROUND

1. Field of the Invention

The present invention relates to mobile inventory control service, and more particularly, to a method and system for providing mobile inventory control service using a mobile communication terminal that are capable of preventing a buyer from ordering goods in excess of an inventory and of not causing buyer dissatisfaction by controlling an inventory of goods of sellers in an online marketplace in real time using a mobile communication terminal of the seller.

2. Discussion of Related Art

Nowadays, there are a number of online marketplaces that provide electronic commerce, such as brokerage of transactions of goods or services, on the Internet.

An online marketplace enables sellers to register and sell their goods or services, and buyers to connect to the online marketplace and selectively purchase desired goods or services, such that the buyers can conveniently purchase, at home, a variety of goods or services registered by the sellers.

Here, the seller inputs goods-related information, such as names and numbers of goods, upon registering the goods in the online marketplace, and the buyer purchases the goods based on the input goods-related information. That is, the buyer will check the registered information about a variety of goods or services and purchase desired goods or services when a purchase condition is satisfied.

In this case, an inventory of the goods is set by the seller. Since the inventory may vary on occasion, the seller must control the inventory.

However, goods information registered in a conventional online marketplace is allowed to be modified by the seller accessing the online marketplace using his or her terminal, such as a desktop computer, a notebook computer, or the like. This requires the terminal to be connected to the Internet in order to modify erroneously registered information, which makes it difficult to rapidly modify the erroneous information.

For example, even though the inventory of goods is erroneously registered, buyers will order the goods based on the inventory. In this case, when a buyer orders goods in excess of the inventory, the seller must prepare additional goods. When failing to prepare the additional goods, the seller must inconveniently return received money to the buyer.

When the seller has to return the received money due to insufficient inventory, or cannot deliver the goods for a long time because of having to prepare additional goods, the seller's reputation of reliability will suffer.

Thus, control of inventory of goods is of importance in the online marketplace.

Accordingly, there is a method for resolving problems of excessive orders by controlling an inventory status of goods registered by a seller in an online marketplace in real time.

### SUMMARY OF THE INVENTION

The present invention is directed to a method and system for providing mobile inventory control service that are capable of controlling an inventory status of goods registered in an online marketplace by a seller in real time using a mobile communication terminal of the seller.

Also, the present invention is directed to a method and system for providing mobile inventory control service that are capable of preventing a buyer from ordering goods in excess of an inventory of the goods registered in an online marketplace due to erroneous indication of the inventory and improving reliability of a seller by enabling the seller to control an inventory status of the goods in real time using his or her mobile communication terminal.

Also, the present invention is directed to a method and system for providing mobile inventory control service that are capable of providing convenience to sellers and buyers by preventing buyers from ordering goods in excess of an inventory of the goods due to erroneous indication of the inventory.

According to an aspect of the present invention, there is provided a method for providing mobile inventory control service, the method including: receiving a text message containing goods information from a mobile communication terminal of a seller; searching for goods corresponding to the received goods information; and setting an inventory status of the searched goods to an out-of-stock status or ending the out-of-stock status.

In this case, receiving the text message containing goods information may include: receiving a text message containing an ID and name of the seller from the mobile communication terminal of the seller; transmitting an authentication number corresponding to the ID and name of the seller to the mobile communication terminal; receiving a text message containing the authentication number and the goods information from the mobile communication terminal; and comparing the authentication number contained in the text message with the authentication number transmitted to the mobile communication terminal. The goods corresponding to the goods information can be searched for when the two authentication numbers match.

In this case, receiving the text message containing goods information may include: receiving a text message containing an ID of the seller and the goods information, and searching for goods may include: when the ID of the seller is in seller information, searching for the goods corresponding to the goods information. Searching for the goods may include: when the seller ID is in the seller information and a calling number from which the text message was sent matches a telephone number corresponding to an ID of the seller, searching for goods corresponding to the goods information.

In this case, searching for the goods may include: searching for the goods when a called number to which the received text message was sent is a key number for setting an inventory status of the goods to the out-of-stock status.

According to another aspect of the present invention, there is provided a method for providing mobile inventory control service using a wireless application protocol (WAP) page, the method including: providing an inventory control page to a mobile communication terminal of a seller accessing through WAP; receiving seller information input through the inventory control page; when the seller information is authenticated, providing goods information of the seller; and setting an inventory status of goods selected by the seller to an out-of-stock status or ending the out-of-stock status.

According to still another aspect of the present invention, there is provided a system for providing mobile inventory control service, the system including an inventory control server for controlling an inventory of goods of a seller based on information received from a mobile communication terminal of the seller, wherein: the inventory control server includes: a receiver for receiving a text message containing goods information of the seller from the mobile communication terminal; a database for storing seller information, goods information, and an inventory status of the goods; and a controller for searching for goods corresponding to the goods information received by the receiver from the database, and setting the inventory status of the searched goods to an out-of-stock status or ending the out-of-stock status.

According to yet another aspect of the present invention, there is provided a system for providing mobile inventory control service using a WAP page, the system including an inventory control server for providing an inventory control page for controlling an inventory of goods of a seller through WAP, wherein: the inventory control server provides the inventory control page to a mobile communication terminal of the seller through WAP, receives seller information input through the inventory control page, provides goods information of the seller upon successful authentication of the seller information, and sets an inventory status of goods selected by the seller to an out-of-stock status or ends the out-of-stock status.

With the method and system for providing mobile inventory control service using a mobile communication terminal according to the present invention, an inventory status of goods registered in an online marketplace by a seller can be controlled in real time using a mobile communication terminal of the seller.

Further, a buyer can be prevented from ordering goods in excess of an inventory of the goods registered in an online marketplace due to erroneous indication of the inventory, and reliability of a seller can be improved by enabling the seller to control an inventory status of the goods in real time using his or her mobile communication terminal.

Furthermore, convenience can be provided to sellers and buyers by preventing buyers from ordering goods in excess of an inventory of the goods due to erroneous indication of the inventory.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 illustrates a configuration of a system for providing mobile inventory control service according to an exemplary embodiment of the present invention;

FIG. 2 is a block diagram illustrating an inventory control server shown in FIG. 1 according to an exemplary embodiment of the present invention.

FIG. 3 illustrates an example of a short message transmitted from a mobile communication terminal of a seller to an inventory control server;

FIG. 4 illustrates another example of a short message transmitted from the mobile communication terminal of the seller to the inventory control server;

FIG. 5 illustrates an example of a short message transmitted from the inventory control server to the mobile communication terminal of the seller;

FIG. 6 illustrates a process of performing inventory control of goods through wireless application protocol (WAP);

FIG. 7 is a flowchart illustrating a method for providing mobile inventory control service according to an exemplary embodiment of the present invention;

FIG. 8 is a flowchart illustrating a method for providing mobile inventory control service according to another exemplary embodiment of the present invention; and

FIG. 9 is a flowchart illustrating a method for providing mobile inventory control service according to still another exemplary embodiment of the present invention.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention.

A mobile communication terminal in the present invention may be a cellular phone, a personal communications services (PCS) phone, or a synchronous/asynchronous International Mobile Telecommunication (IMT)-2000 terminal. Alternatively, the mobile communication terminal may be any communication device, such as a personal digital assistant (PDA), a smart phone, a wireless application protocol (WAP) phone, or a mobile game machine (e.g., a mobile play-station) which is capable of transmitting a text message using mobile communication service or connecting to a server for providing mobile inventory control service through WAP.

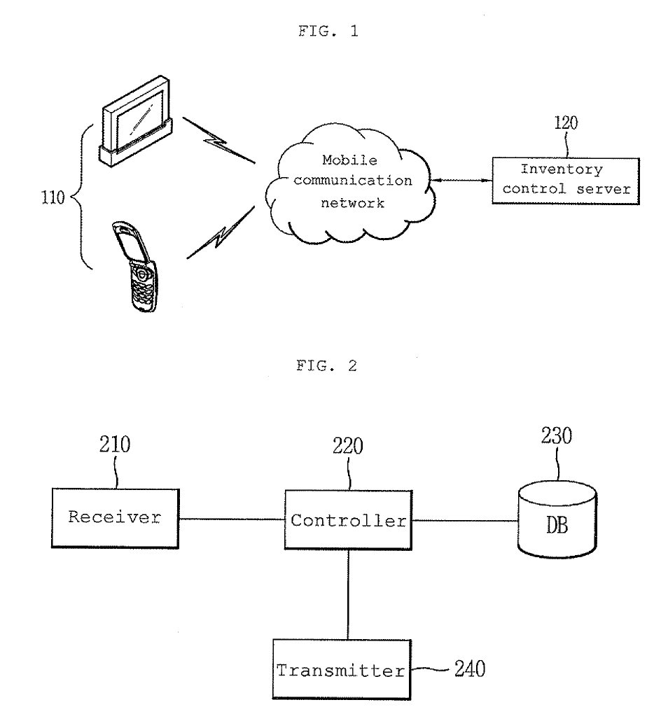

FIG. 1 illustrates a configuration of a system for providing mobile inventory control service according to an exemplary embodiment of the present invention.

Referring to FIG. 1, the system for providing mobile inventory control service includes a mobile communication terminal 110 and an inventory control server 120.

The mobile communication terminal 110 is a terminal of a seller who has registered goods in an online marketplace. The mobile communication terminal 110 transmits a text message for inventory control to the inventory control server 120 over a mobile communication network in order to control an inventory status of the goods stored in the inventory control server 120, or accesses the inventory control server 120 through WAP and controls the inventory status of the goods through an inventory control page provided by the inventory control server 120.

That is, the seller may control the inventory status of the registered goods in real time using his or her mobile communication terminal. Specifically, the seller may control the inventory status using the text message or using the inventory control page provided by the inventory control server 120 through WAP.

It will be easily appreciated that the inventory control server 120 controls the inventory status of the goods in different ways depending on a manner in which the mobile communication terminal 110 controls the inventory status of the goods.

Here, the online marketplace may be uploaded to and controlled by the inventory control server 120 or any other server, such as an online market server. For the sake of concision, this will be not described. The inventory control server 120 in the present invention is a server for controlling all seller-related information registered in the online marketplace.

In this case, the text message transmitted from the mobile communication terminal 110 to the inventory control server 120 may include an ID and name of the seller registered in the online marketplace, an authentication number and a goods number, or the seller ID and the goods number.

For example, the mobile communication terminal 110 transmits a text message containing an ID and name of the seller input by the seller using a key number previously set for inventory control, e.g., “013-XXXX-XXXX” as a called number and, upon receipt of a text message containing an authentication number from the inventory control server 120, transmits a text message containing the received authentication number and the goods number using the called number as a key number, so that the inventory control server 120 controls the inventory status of the goods corresponding to the goods number.

In another example, the mobile communication terminal 110 transmits a text message containing the seller ID and the goods number to the inventory control server 120 using a key number as a called number, such that the inventory control server 120 authenticates the seller based on the information included in the text message and then controls the inventory status of the goods corresponding to the goods number.

The mobile communication terminal 110 may receive the inventory control page from the inventory control server 120 through WAP. In this case, the mobile communication terminal 110 may access the inventory control server 120 using wireless Internet number of contents (WINC) service or any other way. For example, when a set number (e.g., 149, 123, 249, or 324) for accessing a web site provided by the inventory control server 120 through WAP is input and then a WAP connection button (Nate/MagicN/ez-I) is clicked, the mobile communication terminal 110 automatically connects to the inventory control page through WAP.

The inventory control server 120 controls the inventory status of the goods corresponding to the goods number, based on the information received from the mobile communication terminal 110 of the seller.

Here, the inventory control server 120 may detect content of the text message received using a previously set key number and control the inventory status of the goods, such as by setting the inventory status to an out-of-stock status, modifying the inventory number, and ending the out-of-stock status, based on the detected content. When the mobile communication terminal 110 connects to the inventory control server 120 through WAP, the inventory control server 120 may provide the inventory control page to the mobile communication terminal 110 to control the inventory status of the goods in response to seller manipulation.

That is, upon receipt of a text message having content of a predetermined format from the mobile communication terminal 110 using the called number as a key number, the inventory control server 120 performs seller authentication based on the content of the received text message and controls the inventory status of the seller's goods. When the mobile communication terminal 110 connects to the inventory control server 120 through WINC service or through WAP with certain sequential operations, the inventory control server 120 provides the inventory control page to the mobile communication terminal 110 to control the inventory status of the goods in response to seller selection.

For example, upon receipt of a text message containing the ID and name of the seller using the key number, the inventory control server 120 detects the received ID and name of the seller, and compares the detected ID and name of the seller with seller information previously stored in a database. When they match, the inventory control server 120 produces an authentication number and transmits it to the mobile communication terminal 110. When a text message containing the transmitted authentication number and the goods number is received, the inventory control server 120 performs seller authentication by comparing the received authentication number with the transmitted authentication number to determine whether they match. Upon successful seller authentication, the inventory control server 120 can control the inventory status of the goods corresponding to the goods number, such as by setting the inventory status to the out-of-stock status, ending the out-of-stock status, and modifying the inventory number.

In this case, when the calling number as well as the ID and name of the seller match, the inventory control server 120 may produce and transmit the authentication number.

Here, when the inventory status of the goods is set to the out-of-stock status in the database, the inventory control server 120 may end the out-of-stock status, and when it is set to indicate that the goods are in stock, the inventory control server 120 may set the inventory status to the out-of-stock status. When the received text message includes a set inventory number of the goods, the inventory control server 120 may modify the inventory to the set inventory number. Of course, the control of the inventory status may depend on a format of the text message that is set according to setting the inventory status to the out-of-stock status, ending the out-of-stock status, and modifying the inventory number, but the present invention is not limited thereto.

Here, the inventory control server 120 may set key numbers corresponding to setting the inventory status to the out-of-stock status, ending the out-of-stock status, and modifying the inventory number. For example, the inventory control server 120 may set a key number for setting the inventory status to the out-of-stock status to “013-XXXX-XXXX”, a key number for ending the out-of-stock status to “013-0000-0000”, and a key number for modifying the inventory number to “013-XX00-00XX”, and then control the inventory status, such as by setting the inventory status to the out-of-stock status, ending the out-of-stock status, or modifying the inventory number, depending on the called number of the received text message.

In another example, when the text message containing the seller ID and the goods number is received using the key number, the inventory control server 120 performs seller authentication based on the received seller ID and/or calling number. Upon successful seller authentication, the inventory control server 120 may search for goods corresponding to the goods number and control the inventory status.

In still another example, when the mobile communication terminal 110 of the seller connects to the inventory control server 120 through WAP, the inventory control server 120 provides the inventory control page to perform seller authentication and allow the seller to control the inventory status of the goods. Here, seller authentication may be performed by comparing an ID and password of the seller input on the inventory control page with a seller ID and password previously stored in the inventory control server 120.

Thus, the seller can control the inventory status of the goods stored in the inventory control server 120 through the text message or the WAP in real time, thereby preventing the buyer from ordering goods in excess of the inventory due to erroneous indication of the inventory. The indication of a correct inventory of the goods in the online marketplace enables the goods to be rapidly delivered to the buyer and increases the reliability of the seller.

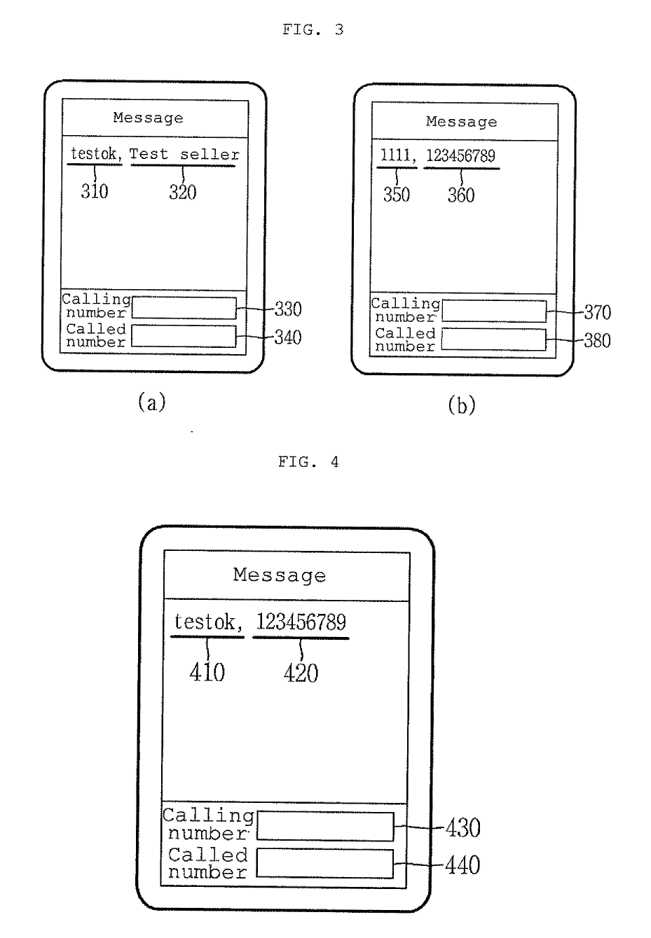

FIG. 2 is a block diagram illustrating the inventory control server shown in FIG. 1 according to an exemplary embodiment of the present invention.

Referring to FIG. 2, an inventory control server 120 includes a receiver 210, a controller 220, a database 230, and a transmitter 240.

The receiver 210 receives a text message from the mobile communication terminal of the seller or information such as seller authentication information and goods search information input through WAP.

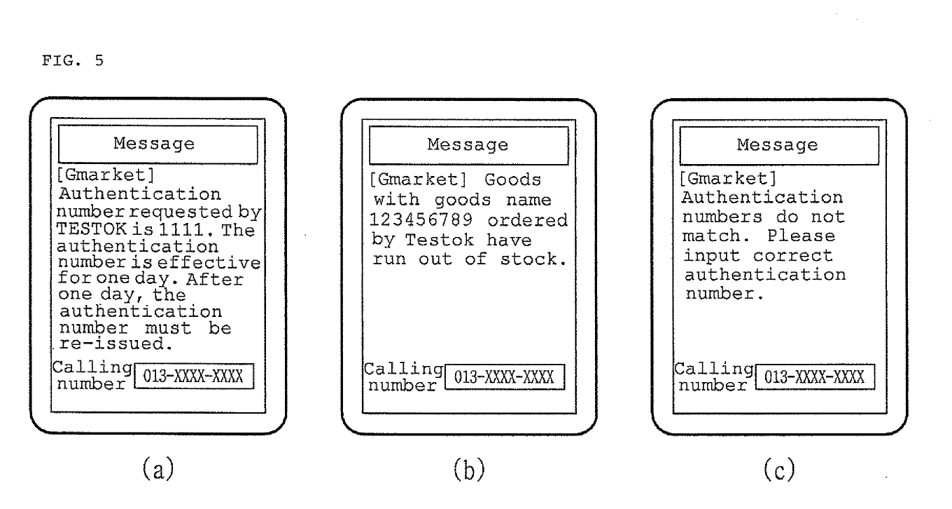

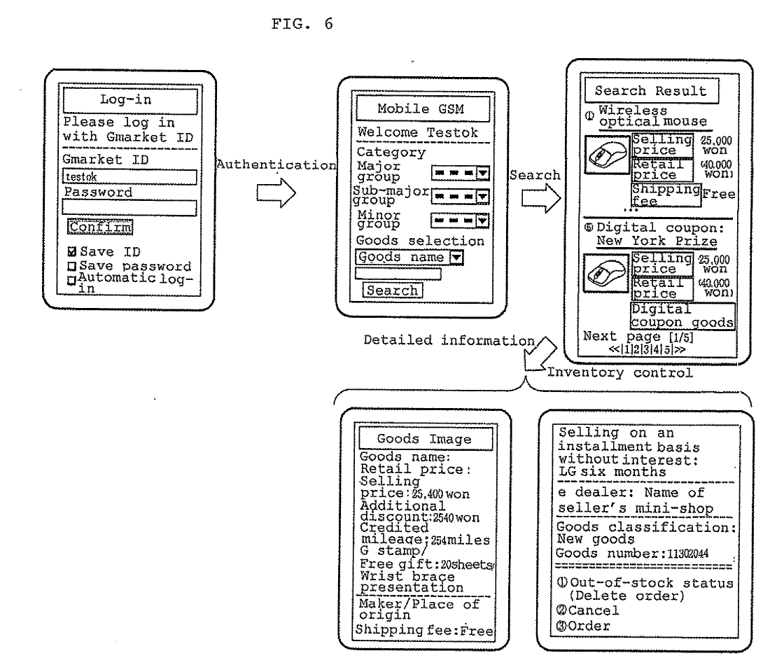

Here, the receiver 210 may receive a text message containing “testok” as an ID 310 of the seller and “test seller” as a name 320 of the seller as in the example shown in FIG. 3a, a text message containing “1111” as an authentication number 350 and “123456789” as a goods number 360 as in the example shown in FIG. 3b, or a text message containing “testok” as an ID 410 of the seller and “123456789” as a goods number 420 as in the example shown in FIG. 4. A called number to which the received text message was sent may be a key number that is previously set for inventory control. That is, each of called numbers 340, 380, and 440 of the text message may be a key number, as in the examples shown in FIGS. 3 and 4. Of course, each of calling numbers 330, 370, and 430 of the text messages may be a telephone number of the seller.

The database 230 stores seller-related information, which may include an ID and name of the seller, a telephone number, a goods number, an inventory of goods, goods information, a credit rating of the seller, and a shipping address.

When the authentication number is transmitted to the mobile communication terminal of the seller, it may be stored in the database 230 for a predetermined period of time.

Under control of the controller 220, the transmitter 240 transmits a text message with predetermined content to the mobile communication terminal of the seller or the inventory control page to the mobile communication terminal connecting to the inventory control server through WAP.

Here, the text message transmitted by the transmitter 240 to the mobile communication terminal may contain the authentication number as in the example shown in FIG. 5a, an indication of the inventory as in the example shown in FIG. 5b, or an indication of seller authentication failure as in the example shown in FIG. 5c. The indication of the inventory may include any one of the out-of-stock status, end of the out-of-stock status, and a modified inventory number.

The controller 220 detects content of the text message received by the receiver 210, and controls the inventory status of the goods, such as by setting the inventory status to the out-of-stock status, ending the out-of-stock status, and modifying the inventory number, based on the detected content of the text message.

In this case, when the called number to which the received text message was sent is a key number for inventory control, the controller 220 may detect the content of the text message.

The content of the text message detected by the controller 220 may be the seller ID and name, the authentication number and the goods number, or the seller ID and the goods number, as in the examples shown in FIGS. 3 and 4.

For example, when the content of the text message detected by the controller 220 includes the seller ID and name as in the example shown in FIG. 3a, the controller 220 compares the seller ID and name with those contained in the seller information in the database 230. When they match, the controller 220 produces the authentication number and transmits a text message containing the produced authentication number to the mobile communication terminal via the transmitter 240, as in the example shown in FIG. 5a. The produced authentication number is stored in the database 230. When the text message containing the authentication number and the goods number as in the example shown in FIG. 3b is received from the mobile communication terminal, the controller 220 compares the received authentication number with the authentication number stored in the database 230. When they match, the controller 220 searches for goods corresponding to the goods number from the database 230 and sets the inventory status of the searched goods to the out-of-stock status. When the inventory status of the searched goods is set to the out-of-stock status, the controller 220 may end the out-of-stock status or set the inventory to a predetermined inventory number previously set by the seller. The predetermined inventory number may be either a value set upon the seller registering the goods in the online marketplace or a modified inventory number in the text message containing the goods number.

In addition, when the calling number from which the text message was sent and the seller telephone number, as well as the seller ID and name, match, the controller 220 may transmit a text message containing the authentication number to the mobile communication terminal of the seller. When seller authentication based on the text message is not successively performed or when the inventory status of the goods is changed, the controller 220 transmits a message indicating that fact, i.e., a message indicating authentication failure (FIG. 5c) or a message indicating the change in the inventory status (FIG. 5b), to the mobile communication terminal.

When a hot number input by the seller is received by the receiver 210 through WAP, i.e., when service for accessing the inventory control server, such as WINC service, is performed on the mobile communication terminal and information indicating the service being performed is received by the receiver 210, the controller 220 provides an inventory control page for controlling an inventory of the goods to the mobile communication terminal through WAP.

When the seller ID and password are received after the inventory control page is provided through WAP, i.e., when the seller ID and password are input through the inventory control page, the controller 220 performs seller authentication based on the input seller ID and password, and provides goods information through WAP upon successful authentication, so that the seller can perform inventory control.

It will be easily appreciated that the controller 220 may perform seller authentication based on the seller telephone number as well as the seller ID and password input through WAP.

Thus, the controller 220 controls the inventory status of the goods in real time, such as by setting the inventory status to the out-of-stock status, ending the out-of-stock status, and modifying the inventory number, based on the text message or the seller information input through WAP, thereby preventing the buyer from ordering goods in excess of the inventory due to erroneous indication of the inventory.

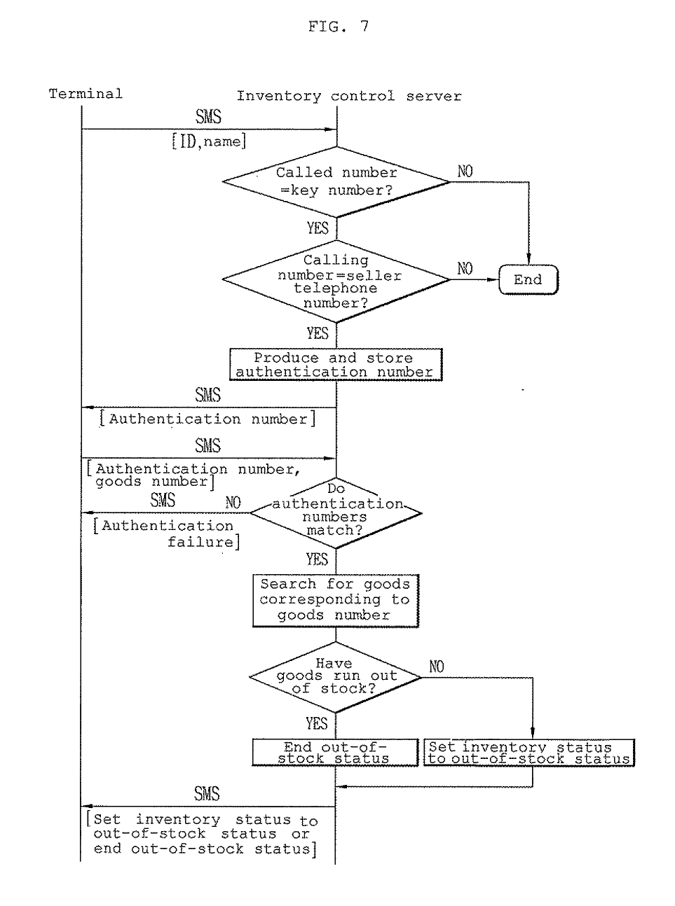

The inventory control service provided by the inventory control server 120 through WAP will now be described with reference to FIG. 6.

When the mobile communication terminal of the seller connects to the inventory control server 120 through WAP, the inventory control server 120 provides a page having an input section for inputting an ID (e.g., a Gmarket ID) and a password of the seller. When the seller inputs the ID and the password, the inventory control server 120 compares the input ID and password with a seller ID and password previously stored in the database 230 to perform seller authentication.

Here, ID saving, password saving, and automatic log-in functions may be provided according to seller selection, as shown in FIG. 6. The automatic log-in function may be set to be automatically ended when the seller does not access the inventory control server 120 for a predetermined period of time, e.g., one month.

Upon successful seller authentication, the inventory control server 120 provides a page for searching for goods registered by the seller, allowing the seller to search for goods by at least one of a category, a goods name, and a goods number. It will be easily appreciated that goods may be searched for by items other than the above-described items.

When goods are searched for, the inventory control server 120 provides a list of the searched goods. When goods to be controlled for an inventory are selected from the goods list, an item for controlling detailed information and the inventory status for the selected goods is displayed.

In this case, the list of goods may be displayed showing a predetermined number of goods with brief information about the goods.

Although the item for setting the inventory status to the out-of-stock status is shown as an item for controlling the inventory status in FIG. 6, the present invention is not limited thereto. Alternatively, several items, such as for ending the out-of-stock status and modifying the inventory number as well as setting the inventory status to the out-of-stock status, may be displayed.

Thus, the present invention provides the mobile inventory control service using WAP, such that the seller can control the inventory status of the goods in real time using his or her mobile communication terminal.

Furthermore, the system for providing mobile inventory control service according to the present invention can control the inventory of goods using a mobile communication terminal, in which the inventory status controlled on the mobile communication terminal is directly reflected in the online marketplace, thereby enabling the seller to confirm the inventory status by accessing the online marketplace over wired or wireless Internet. Displaying the inventory reflected through the mobile communication terminal can prevent the buyer from ordering goods in excess of the inventory.

FIG. 7 is a flowchart illustrating a method for providing mobile inventory control service according to an exemplary embodiment of the present invention, in which the inventory control server transmits an authentication number to the mobile communication terminal.

Referring to FIG. 7, according to the method for providing mobile inventory control service, upon receipt of a short message service (SMS) message containing the ID and name of the seller from the mobile communication terminal of the seller, the inventory control server determines whether a called number of the received SMS message is a key number previously set for inventory control.

When it is determined that the called number is the key number, the inventory control server determines whether the calling number of the SMS message matches the seller telephone number corresponding to the ID and name of the seller.

When the calling number matches the seller telephone number, the inventory control server produces an authentication number to be transmitted to the mobile communication terminal of the seller and stores the produced authentication number in the database.

That is, the inventory control server produces the authentication number when the called number in the short message is the key number and the calling number is the seller telephone number.

Alternatively, the authentication number may be produced when the called number is the key number or when the called number is the key number and the ID and name of the seller is in the database of the inventory control server.

Of course, when the called number is not the key number or the calling number is not the seller telephone number, the inventory control service ends.

The inventory control server transmits the short message containing the produced authentication number to the mobile communication terminal of the seller, and, upon receipt of a short message containing the authentication number and the goods number from the mobile communication terminal, detects the received authentication number and compares the detected authentication number with the authentication number stored in the database to perform seller authentication.

When the two authentication numbers match, the inventory control server searches for goods corresponding to the goods number contained in the short message from the database, and determines whether the inventory status of the searched goods is an out-of-stock status, based on an item indicating the inventory status of the goods stored in the database.

On the other hand, when the two authentication numbers do not match, the inventory control server produces a short message indicating seller authentication failure and transmits it to the mobile communication terminal of the seller so that the seller can recognize the authentication failure.

Here, when the goods corresponding to the goods number are not stored in the database, the inventory control server may transmit a text message indicating that fact, i.e., a text message containing an indication no registration of the goods to the mobile communication terminal.

The inventory control server ends the out-of-stock status when the goods run out of stock and sets the inventory status to the out-of-stock status when the goods are in stock.

When the inventory status of the goods is changed, the inventory control server transmits a short message to the mobile communication terminal indicating that the inventory status changed by setting the inventory status to the out-of-stock status or ending the out-of-stock status, so that the seller can recognize the changed inventory status.

Although only setting the inventory status to the out-of-stock status and ending the out-of-stock status are shown in FIG. 7, the present invention is not limited thereto. Alternatively, the seller may directly set the inventory to a predetermined inventory number. For example, as the buyer transmits an inventory number in the SMS message containing the authentication number and the goods number, the inventory control server modifies the inventory of goods into the inventory number indicated by the SMS message, i.e., set by the seller. The SMS message may have a format determined by an inventory control service provider.

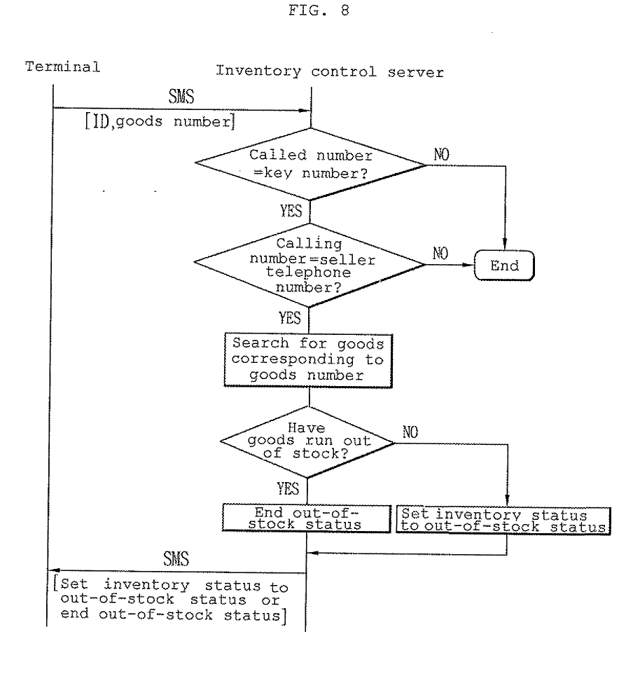

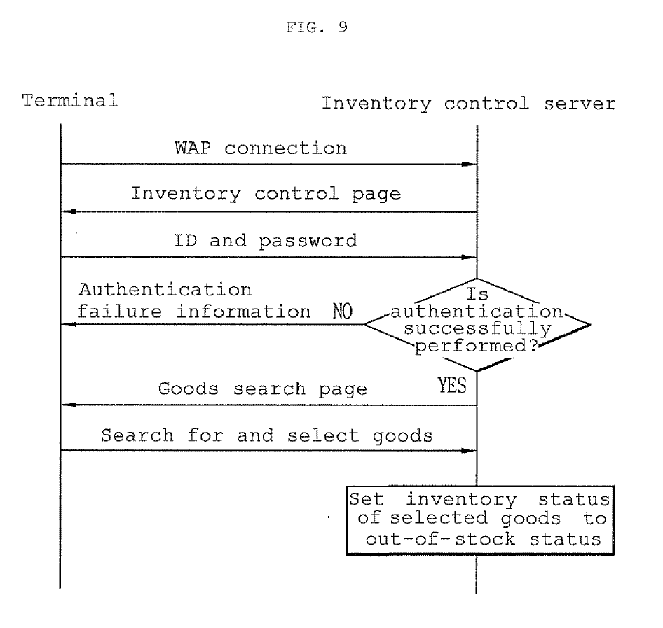

FIG. 8 is a flowchart illustrating a method for providing mobile inventory control service according to another exemplary embodiment of the present invention, in which an inventory control server performs seller authentication based on the information contained in the short message.

Referring to FIG. 8, in the method for providing mobile inventory control service, when the inventory control server receives a short message (SMS message) containing the seller ID and the goods number from a mobile communication terminal of the seller, the inventory control server determines whether a called number of the received short message is a key number.

When it is determined that the called number is a key number, the inventory control server determines whether the calling number of the short message matches the seller telephone number corresponding to the ID and name of the seller.

When the calling number matches the seller telephone number, the inventory control server recognizes that seller authentication is successfully performed, searches for goods corresponding to the goods number in the short message from the database, and determines whether the searched goods run out-of-stock.

When the called number is not the key number or when the calling number is not the seller telephone number, the inventory control service ends.

In this case, when the seller ID in the short message is in the seller information stored in the database, the inventory control server may recognize successful authentication and search for the goods. That is, seller authentication may be performed based on at least one of the seller ID and the calling number.

The inventory control server ends the out-of-stock status when the goods run out of stock, and sets the inventory status to the out-of-stock status when the goods are in stock.

In FIG. 8, the present invention is not limited only to setting the inventory status to the out-of-stock status and ending the out-of-stock status, but the seller may directly set the inventory to a predetermined inventory number, as in FIG. 7.

As illustrated in FIGS. 7 and 8, in the method for providing mobile inventory control service according to the present invention, the seller can be authenticated using the short message received from the mobile communication terminal of the seller, i.e., using at least one of the seller ID, the authentication number, and the calling number contained in the short message, and then the inventory status of the goods contained in the short message can be controlled in real time.

Although the text message carrying the seller information is illustrated to be the short message in FIGS. 7 and 8, the present invention is not limited thereto. The text message may include any text message including a long message service (LMS) message and a multimedia message service (MMS) message that are capable of conveying the inventory control information.

FIG. 9 is a flowchart illustrating a method for providing mobile inventory control service according to another exemplary embodiment of the present invention, in which an inventory of goods is controlled using WAP.

Referring to FIG. 9, when the mobile communication terminal of the seller is connected to the inventory control server through WAP, that is, when the seller connects to the inventory control server using the mobile communication terminal through WINC service, the inventory control server provides an inventory control page for controlling an inventory of the goods to the mobile communication terminal through WAP.

When an ID and password of the seller are input through an input section of the inventory control page for performing seller authentication, e.g., an ID and password input section, the inventory control server compares the input seller ID and password with the ID and password in the seller information stored in the database to perform seller authentication. When they match, the inventory control server determines that the seller is successively authenticated, and otherwise determines that the seller is not successively authenticated.

When seller authentication fails, the inventory control server transmits information indicating the authentication failure to the mobile communication terminal of the seller through WAP. When seller authentication is successfully performed, the inventory control server provides a goods search page for searching for goods registered by the seller.

The seller searches for the goods based on the goods name, goods number, and the like on the provided goods search page to control the inventory status.

When the searched goods are selected, the inventory status of the selected goods may be automatically set to the out-of-stock status. The inventory status may be controlled in response to a selection of an inventory-related item among items for providing information on the selected goods, setting the inventory status to the out-of-stock status, and ending the out-of-stock status.

The functions of the method and system of the present invention can be implemented as computer-readable code in a computer-readable recording medium. The computer-readable recording medium is any recording medium for storing data that can be read by a computer system. Examples of the computer-readable recording medium include a read-only memory (ROM), a random access memory (RAM), a compact disk-read only memory (CD-ROM), a magnetic tape, a floppy disk, and optical data storage. Alternatively, the medium may be implemented in the form of carrier waves (e.g., Internet transmission). The computer-readable recording medium may be distributed among networked computer systems, and the computer-readable code may be stored and executed in a decentralized manner.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for providing mobile inventory control service, the method comprising:
receiving a text message containing goods information from a mobile communication terminal of a seller;
searching for goods corresponding to the received goods information; and
setting an inventory status of the searched goods to an out-of-stock status or ending the out-of-stock status.

2. The method of claim 1, wherein receiving the text message containing goods information comprises:
receiving a text message containing an ID and name of the seller from the mobile communication terminal of the seller;
transmitting an authentication number corresponding to the ID and name of the seller to the mobile communication terminal;
receiving a text message containing the authentication number and the goods information from the mobile communication terminal; and
comparing the authentication number contained in the text message with the authentication number transmitted to the mobile communication terminal,
wherein when the two authentication numbers match, the goods corresponding to the goods information are searched for.

3. The method of claim 2, wherein transmitting the authentication number to the mobile communication terminal comprises: transmitting the authentication number to the mobile communication terminal when a calling number for the received text message matches a previously stored telephone number of the seller.

4. The method of claim 2, further comprising when the two authentication numbers do not match, transmitting a text message indicating the mismatch to the mobile communication terminal.

5. The method of claim 1, wherein receiving the text message containing goods information comprises receiving a text message containing an ID of the seller and the goods information, and
searching for the goods comprises when the ID of the seller is in seller information, searching for the goods corresponding to the goods information.

6. The method of claim 1, wherein searching for the goods comprises when a calling number from which the text message was sent matches a telephone number corresponding to an ID of the seller, searching for goods corresponding to the seller ID and the goods information.

7. The method of claim 1, wherein searching for the goods comprises searching for the goods when a called number to which the received text message was sent is a key number for setting an inventory status of the goods to the out-of-stock status.

8. The method of claim 1, wherein when a called number to which the received text message was sent is a key number for ending an out-of-stock status, the out-of-stock status of the searched goods is ended.

9. The method of claim 1, further comprising: determining whether the searched goods run out of stock, wherein setting the inventory status of the searched goods to an out-of-stock status or ending the out-of-stock status comprises setting the inventory status of the goods to the out-of-stock status when the goods are in stock.

10. The method of claim 9, wherein setting the inventory status of the searched goods to an out-of-stock status or ending the out-of-stock status comprises ending the out-of-stock status when the goods run out of stock.

11. The method of claim 1, further comprising transmitting a text message indicating that the out-of-stock status is set or ended, to the mobile communication terminal.

12. The method of claim 1, further comprising:
when the goods are not searched for, transmitting a text message indicating that the goods are not searched for to the mobile communication terminal.

13. The method of claim 1, wherein when an inventory number of the goods is included in the text message, the inventory of the searched goods is set to the inventory number.

14. A method for providing mobile inventory control service using a wireless application protocol (WAP) page, the method comprising:
providing an inventory control page to a mobile communication terminal of a seller accessing through WAP;
receiving seller information input through the inventory control page;
when the seller information is authenticated, providing goods information of the seller; and
setting an inventory status of goods selected by the seller to an out-of-stock status or ending the out-of-stock status.

15. A recording medium having a computer-readable program stored thereon for performing a method according to any one of claims 1.

16. A system for providing mobile inventory control service, the system comprising an inventory control server for controlling an inventory of goods of a seller based on information received from a mobile communication terminal of the seller, wherein the inventory control server comprises:
a receiver for receiving a text message containing goods information of the seller from the mobile communication terminal;
a database for storing seller information, goods information, and an inventory status of the goods; and
a controller for searching for goods corresponding to the goods information received by the receiver from the database, and setting the inventory status of the searched goods to an out-of-stock status or ending the out-of-stock status.

17. The system of claim 16, wherein the controller searches for the goods from the database when a called number for the text message received by the receiver is a key number for setting the inventory status to an out-of-stock status.

18. The system of claim 16, wherein the controller compares an authentication number with an authentication number transmitted to the mobile communication terminal and stored in the database when the text message received by the receiver contains the authentication number, and searches for the goods of the seller from the database when the two authentication numbers match.

19. The system of claim 16, wherein the controller compares a calling number from which the text message was sent with a telephone number corresponding to an ID of the seller stored in the database when the text message received by the receiver contains the ID of the seller, and searches for goods of the seller corresponding to the goods information when the calling number matches the telephone number.

20. The system of claim 16, wherein the controller sets the inventory status of the searched goods to the out-of-stock status when the searched goods are in stock, and ends the out-of-stock status when the goods run out of stock.

21. The system of claim 16, wherein the inventory control server further comprises a transmitter for transmitting a text message to the mobile communication terminal of the seller under control of the controller indicating that the out-of-stock status is set or ended.

22. The system of claim 16, wherein the controller sets the inventory of goods to an inventory number when the inventory number of the goods is included in the text message received by the receiver.

23. A system for providing mobile inventory control service using a WAP page, the system comprising an inventory control server for providing an inventory control page for controlling an inventory of goods of a seller through WAP,
wherein the inventory control server provides the inventory control page to a mobile communication terminal of the seller through WAP, receives seller information input through the inventory control page, provides goods information of the seller upon successful authentication of the seller information, and sets an inventory status of goods selected by the seller to an out-of-stock status or ends the out-of-stock status.
